(19) United States
(12) Patent Application Publication
(10) Pub. No.: US 2008/0318184 A1
(43) Pub. Date: Dec. 25, 2008

(54) Vibratory Dental Tool

(76) Inventors: Brian Zargari, Los Angeles, CA (US); Pejman Fani, Los Angeles, CA (US); Christopher Quan, Houston, TX (US)

Correspondence Address: DISCUS DENTAL, LLC, 8550 HIGUERA STREET, CULVER CITY, CA, 90232, US

(21) Appl. No.: 12/139,380

(22) Filed: Jun. 13, 2008

Related U.S. Application Data
(60) Provisional application No. 60/943,637, filed on Jun. 13, 2007.
(60) Provisional application No. 60/982,107, filed on Oct. 23, 2007.

(51) Int. Cl. A61C 3/03

(52) U.S. Cl. 433/119

(57) ABSTRACT

A powered dental tool generally includes a tool tip at its distal end, a body at its proximal end and a motion generating mechanism. In one aspect, the dental tool includes a tool tip having a proximal end and a distal end along a generally longitudinal axis and a reciprocating motion generating mechanism. The reciprocating motion generating mechanism may repeatedly move the tool tip generally back and forth by a given displacement generally along the tool tip's longitudinal axis. This displacement generally resembles the action of a hand scaler, i.e., a reciprocating motion along the longitudinal axis of the scaler, which is unlike the vibration of most powered scalers. Such action may be advantageous as it may be more intuitive for the dental professional or hygienist and may provide more effective scaling action. It may further be advantageous for a powered scaler to more closely resemble a hand scaler in form, which is small, portable and untethered. In one embodiment, the motion generating mechanism may include a rotational source and set of opposing magnetic transfer elements.

### CROSS-REFERENCE TO RELATED APPLICATIONS

This application claims the benefit of U.S. provisional patent applications: Ser. No. 60/943,637 entitled “Vibratory Dental Tool” filed on Jun. 13, 2007; and 60/982,107, entitled “Vibratory Dental Tool” filed Oct. 23, 2007; the contents of all are hereby incorporated by reference in their entirety.

### FIELD OF THE INVENTION

The present invention relates to dental tools, and particularly to dental hygiene tools.

### BACKGROUND OF THE INVENTION

Scaling is a dental procedure that consists of using a dental tool, called a scaler, to remove calculus and other material from the surface of the teeth.

Manually scaling the teeth is an intensive process that requires a great deal of force to be exerted through the scaler. This may lead to strain and fatigue on the dental hygienist which may cause their performance to diminish during the course of a procedure.

Powered scaling tools are common in dental offices in the form of ultrasonic and sonic scalers. Sonic scalers are commonly used in dental facilities to clean plaque, tartar and other hard deposits from the teeth of patients and usually consist of a hand held drive assembly with a rapidly vibrating tip driven by compressed air. The drive assembly converts the energy from the compressed air to a high frequency movement of the tip. The tip rapidly vibrates to aid in removing deposits from the tooth surfaces. The shape of the tip is often hook shaped to assist the user in reaching hard to reach locations between the teeth. The motion of the tip is typically a lateral vibration from the long axis of the tip. This motion is generally not along the longitudinal axis of the tip and thus does not mimic the motion of a manual scaler.

Ultrasonic scalers vibrate at very high frequencies and are driven by magnetostrictive metal stacks or piezoelectric elements, higher frequency than sonic scalers powered by compressed air, as noted above. Both types of scalers provide powered scaling that decreases the amount of effort required from the dental professional or hygienist. However, powered scalers are tethered by their power/water/air lines and thus create difficulty in handling and maneuvering in the dental office.

### SUMMARY OF THE INVENTION

The present invention is directed to powered dental scaler tools that improve portability, maneuverability, and more closely resemble hand scalers in form and action. The present invention is also directed to motion generating mechanisms for dental tools.

A powered dental tool generally includes a tool tip at its distal end, a body portion at its proximal end and a motion generating mechanism disposed somewhere inside the body portion. One portion of the body portion may also function as a handle for grasping by a dental professional. In one aspect, the dental tool includes a tool tip having a generally longitudinal axis, a proximal end adjacent to the body portion and a distal end; and a reciprocating motion generating mechanism. The reciprocating motion generating mechanism may repeatedly move the tool tip in a generally back and forth direction by a given displacement generally along the tool tip's longitudinal axis. This displacement generally resembles the action of a hand scaler, i.e., a reciprocating motion along the longitudinal axis of the scaler, which is unlike the vibration of most, if not all, powered scalers. Such action may be advantageous as it may be more intuitive for the dental professional or hygienist and may also provide more effective scaling action. It may further be advantageous for a powered scaler to more closely resemble a hand scaler in form, which is small, portable and untethered.

In one embodiment of the invention, the motion generating mechanism may include at least one rotational source and at least one set of opposing magnetic transfer elements, each having at least one North pole domain and one South pole domain, and which may be coupled to the output shaft of the rotational source and the proximal end of the tool tip. The opposing magnetic transfer elements may in general possess at least one axis of asymmetry on the opposing faces and may be coupled such that they face each other with like poles, such as, for example, North to North or South to South at a proximity such that they may magnetically influence each other, i.e, repel each other. Magnetic transfer elements may be particularly desirable as the elements may still influence each other without being in direct contact, which may offer increased flexibility in design. Portions of the dental tool may also be physically isolated for contamination control without significantly interfering with the influence of the magnetic transfer elements on each other. The tool tip may be reciprocated along its longitudinal axis by rotating the magnetic transfer element coupled to the drive shaft of the rotational source. The rotation may then create at least one period during a revolution when the opposing magnetic fields of the magnetic transfer elements are misaligned. The misalignment may in general create a variation in the repulsive forces between the magnetic transfer elements, the force of which may be translated to the tool tip coupled to at least one magnetic transfer element to cause displacements along the longitudinal axis, resulting in the reciprocation effect.

In an exemplary embodiment, the magnetic transfer elements may include North and South pole domains on the opposing faces such that during the rotation of at least one of the magnetic transfer elements coupled to the rotational source.

In one embodiment, each revolution of 360°, at least one of the magnetic transfer elements may create at least one alignment of opposite poles, i.e. North to South, and at least one alignment of like poles, e.g. North to North or South to South, the times of which do not coincide. The alignment of opposite poles may in general cause an attractive force which may retract the tool tip toward the magnetic transfer element coupled to the rotational source and the alignment of like poles may in general cause a repulsive force which push the tool tip away, resulting in a reciprocating action of the tool tip on the work surface. The rotation may be in a continuous mode.

In another embodiment, the rotational source may create a rocking, oscillating, or flipping motion, enabling the magnetic transfer elements to mechanically rock, oscillate, or flip from an alignment of opposite poles, i.e. North to South, or at least one alignment of like poles, e.g. North to North or South to South, to the alignment of opposite poles or like poles, respectively, again resulting in a reciprocating action of the tool tip on the work surface, in a more discrete mode of rotation. In one aspect, the rotation may be carried out with a single reciprocating source, such as a motor. In this aspect, the life of the instrument or tool may be controlled by any magnetic hysteresis effects that may be created in the motor. In another aspect, the rotation may be carried out with two separate sources or motors, one for flipping, oscillating or rocking in one direction and the other for flipping or rocking in the opposite direction, not at the same time. In this aspect, no hysteresis effects may be created.

The rotational source may be any appropriate source, which may include, but is not limited to, electric motors, transducers, turbines, and/or any other appropriate source or combinations thereof. The rotational source may be powered by any appropriate source, such as, for example, any energy storage reservoir including a battery, removable or non-removable and rechargeable; an electrical fuel cell or a fuel storage reservoir; a capacitor; external electric source; pressurized gas/fluid source; and/or any other appropriate source or combinations thereof.

In another embodiment of the invention, the motion generating mechanism may include at least one magnetic transfer element, a coil and an alternating current (AC) source. The magnetic transfer element may include at least one North pole domain and one South pole domain and may be coupled to the tool tip. A coil may be wound about the magnetic transfer element such that the magnetic transfer element is generally disposed along one axis of the coil. The coil may be connected to an AC source such that the current in the coil may generate a magnetic field. The magnetic field may in general alternate polarity in response to an AC current power supply such that the domains of the magnetic transfer element may, in an alternating fashion, align and misalign with the magnetic field of the coil. The aligning and misaligning may in general generate a reciprocating motion of the magnetic transfer element and the coupled tool tip along the magnetic axis of the coil.

Other embodiments of the invention may include multiple coils, flat coils and/or magnetic cores within the coils.

In some embodiments, the dental tool may further include a spring element. The spring element may generally bias the tool tip against motion along its longitudinal axis such that it may resist loads in a given direction. The spring element may further aid in returning the tool tip to a starting position in each reciprocating action.

In general, the body of the dental tool may include features or formations that may restrain the tool tip in attachment to the dental tool and restrict the motion of the tool tip to a given range. Suitable features or formations may include, but are not limited to, restraining members, varied cross-section regions, bushings, bearings and/or any other appropriate features or formations.

In another aspect, the dental tool may include separable components. In general, dental tools are sterilized prior to use to reduce contamination risk and maintain a clean environment. As such, it may be desirable for the dental tool to include easily sterilizable components. In one embodiment, the dental tool may include separable tool tips. Any powered and/or temperature/moisture sensitive components of the dental tool may in general be disposed such that they may be retained in a portion of the dental tool separate from the separable tool tips such that the tool tips may be sterilized by an appropriate method, such as, for example, autoclaving. The separable tool tips may also include housing portions that may substantially cover portions of the dental tool that are not sterilized. Separable components may also be environmentally desirable so that only the components that are worn are replaced.

In other aspects, the powered and/or temperature/moisture sensitive components of the dental tool may be removable from the dental tool such that the dental tool may be sterilized separately.

In still other aspects, at least one vibrator module may be positioned and resiliently supported inside the body portion towards one end of the body. The rotational source already present may also be adapted to rotate an eccentric weight to cause a vibration in the tip in addition to the reciprocating action.

The module may also include a small motor adapted to rotate the eccentric weight to cause a vibration in the tip in addition to the reciprocating action.

The present invention is further directed to a set of dental instruments with ergonomically designed body portion for grasping, each instrument in the set may also be made with varying diameter body portion for stress release during the day.

In one aspect of the invention, any of the above embodiments, a tip may extend from each end of the housing.

In another aspect of the invention, at least one end of the body portion to which the tip extends may be rotatable wherein such rotation also rotates the dental tip so that the tip may be easily repositioned without being taken out of the patient's mouth during use.

The present invention together with the above and other advantages may best be understood from the following detailed description of the embodiments of the invention below, which is provided in conjunction with the accompanying drawings.

### BRIEF DESCRIPTION OF THE FIGURES

FIG. 1 illustrates a double-ended dental scaler instrument or tool in one embodiment of the present invention;

FIG. 1a illustrates a single-ended dental scaler instrument or tool of the present invention;

FIG. 2 is a partial cross-sectional view of a powered dental scaler instrument in one embodiment of the present invention;

FIGS. 2a and 2b illustrate magnetic motion generating mechanisms of the present invention;

FIG. 2c illustrates a magnetic motion generating mechanism of the present invention having two motors;

FIGS. 3-3f illustrate the construction and function of a magnetic motion generating mechanism of the present invention;

FIG. 4 illustrates a double-ended dental scaler with separable scaler ends and motion pack in one embodiment of the present invention;

FIG. 4a is a partial cross-sectional view of one embodiment of a separable scaler end and motion pack;

FIG. 4b is a partial cross-sectional view of another embodiment of a separable scaler end;

FIG. 4c is a partial cross-sectional view of an embodiment of a motion pack;

FIGS. 4d and 4e illustrate another embodiment of a double-ended dental scaler instrument with separable scaler ends and motion pack;

FIG. 4f illustrates a rocker switch actuator;

FIGS. 5-5c illustrate embodiments of powered dental scaler instruments with removable components;

FIGS. 6-6d illustrate embodiments of dental scaler instruments with spring elements;

FIGS. 7-7c illustrate embodiments of magnetic motion generating mechanism with coils;

FIG. 8 shows a perspective view of a set of ergonomically designed dental instruments with varying diameters;

FIG. 8a shows an embodiment of a dental scaler instrument of FIG. 1 having a handgrip;

FIG. 8b shows an eccentric weight attached to a rotating shaft;

FIG. 8c-f show different embodiments of an eccentric load;

FIG. 9 shows a dental scaler instrument with a rotatable tip;

FIG. 10 shows an exploded view of a dental scaler instrument having a rotator head; and

FIG. 11 shows a hand grip adapted for fitting onto a dental scaler instrument.

### DETAILED DESCRIPTION OF THE INVENTION

The detailed description set forth below is intended as a description of the presently exemplified device provided in accordance with aspects of the present invention and is not intended to represent the only forms in which the present invention may be practiced or utilized. It is to be understood, however, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described herein can be used in the practice or testing of the invention, the exemplified methods, devices and materials are now described.

The vibration of most, if not all, powered scalers, does not closely resemble the motion of a hand scaler, i.e., a reciprocating motion along the longitudinal axis of the scaler. A power scaler instrument having such reciprocating action may be advantageous as it may be more intuitive for the dental professional or hygienist and may provide more effective scaling action. It may further be advantageous for a powered scaler instrument to more closely resemble a hand scaler in form, which is small, portable and un-tethered.

The present invention relates to dental instruments or tools, in particular to powered dental scaler tools that improve portability, maneuverability, and more closely resemble hand scalers in form and action. The present invention is also directed to motion generating mechanisms for generating reciprocating motion in dental instruments or tools.

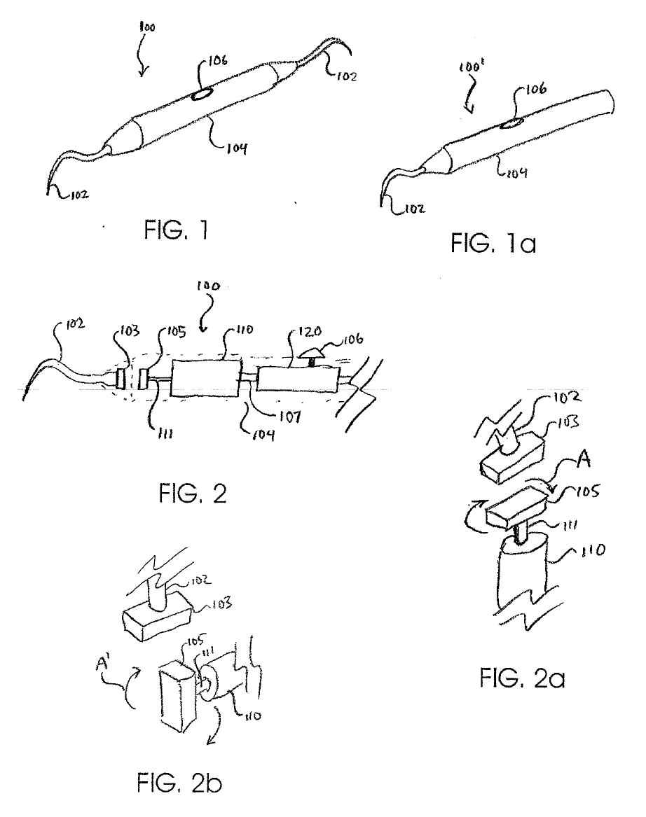

In one exemplary embodiment, as shown in FIG. 1a, a powered dental tool 100 generally includes a tool tip 102 at its distal end, a body portion 104 at its proximal end and a motion generating mechanism (not shown) at least partially disposed somewhere in the body portion 104. The tool 100 may further include at least one actuator 106 disposed on the outside of the body portion 104 that may control the motion generating mechanism. In some embodiments, the tool 100 may have two tool tips 102 at opposite ends, such as shown in FIG. 1. The tool tips 102 may be identical or they may be different such that each tool 100 may offer multiple tip forms. It may generally be appreciated that any components associated with one tool tip 102 may also apply to a second tool tip and any type of working tip may be contemplated herein.

In one aspect, the dental tool tip 102 includes a generally longitudinal axis, a proximal end, a distal end, and portions of a reciprocating motion generating mechanism disposed towards its proximal end. The reciprocating motion generating mechanism may repeatedly move the tool tip 102 generally back and forth by a given displacement generally along the tool tip's longitudinal axis.

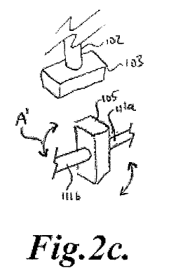

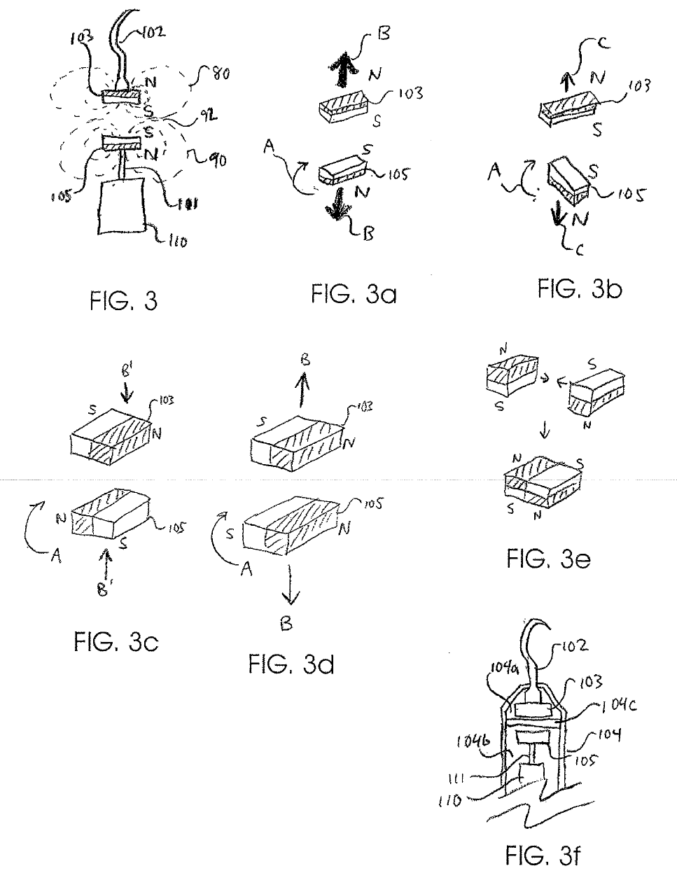

A dental tool 100 may include a tool tip 102 and a reciprocating motion generating mechanism, a partial cross-section of which is shown in FIG. 2. In one embodiment, the motion generating mechanism may include a rotational source 110 and at least one set of opposing magnetic transfer elements 103, 105, each having at least one North pole domain and one South pole domain, and which may be coupled to the proximal end of the tool tip 102 and output shaft 111 of the rotational source 110, respectively. The opposing magnetic transfer elements 103, 105 may in general possess at least one axis of asymmetry on the opposing faces, such as with rectangular elements, and may be coupled such that they face each other with like poles, for example, North to North or South to South, with a proximity such that they may magnetically influence each other, an example of which is shown in FIG. 3. The tool tip 102 may be reciprocated along its longitudinal axis by rotating the magnetic transfer element 105 that is coupled to the drive shaft 111 of the rotational source 110, as shown in FIGS. 2a and 2b. The rotation of the magnetic transfer element 105 may be generally about the longitudinal axis of the tool tip 102, as shown in FIG. 2a, or the axis of rotation may be at an angle to the longitudinal axis of the tool tip 102, as shown with a perpendicular orientation in FIG. 2b. The rotation A or A′ of the magnetic transfer element 105 may then create at least one period during a revolution when the opposing magnetic fields 80, 90 of the magnetic transfer elements 103, 105 are aligned, such as exemplified in FIG. 3a, and one period during which the fields 80, 90 are misaligned, such as exemplified in FIG. 3b. The misalignment may in general create a variation in the repulsive force between the magnetic transfer elements 103, 105, such as shown with the greater force magnitude B of FIG. 3a and the smaller force magnitude C of FIG. 3b, the force of which may be translated to the tool tip 102 coupled to magnetic transfer element 103 to cause reciprocation.

In an exemplary embodiment, the magnetic transfer elements 103, 105 may include North and South pole domains on the opposing faces, as shown in FIGS. 3c and 3d, such that during the rotation of the magnetic transfer element 105 coupled to the rotational source 110, each revolution may create at least one alignment of opposite poles, i.e. North to South, as shown in FIG. 3c, and at least one alignment of like poles, e.g. North to North or South to South, as shown in FIG. 3d, the times of which may not coincide. The alignment of opposite poles may in general cause an attractive force B′ which may retract the tool tip 102 toward the magnetic transfer element 105 coupled to the rotational source 110 and the alignment of like poles may in general cause a repulsive force B which may push the tool tip 102 away from the transfer element 105, resulting in an overall reciprocating action of the tool tip 102 during rotation of the magnetic transfer element 105. In general, the frequency of the reciprocation may be a multiple of the rotations of the magnetic transfer element 105. The multiple may generally be affected by the number and disposition of magnetic pole domains on the magnetic transfer elements 103, 105.

Multiple magnetic pole domains may be constructed by, for example, joining multiple separate magnetic transfer elements together, such as shown in FIG. 3e.

The rotational motion of the magnetic transfer element 105 may be in a continuous mode instead of a discontinuous mode, with the tool tip 102 reciprocating continuously.

In another exemplary embodiment, the rotation of the magnetic transfer element 105 may resemble a back and forth rocking, oscillating or flipping motion. The motion may generate a reciprocal motion in the dental scaler instrument 100, during alignment of the magnetic poles or misalignment of the magnetic poles of the transfer elements 103 and 105. In one embodiment, the rocking, oscillating or flipping motion may be generated by one reciprocating rotational source, such as by alternating the direction of rotation A′ of rotational source 110 in FIG. 2b. In another embodiment, the rocking, oscillating or flipping motion may be generated by two rotational sources, one for rocking in one direction, i.e., alignment; and one for rocking in the opposite direction, i.e., misalignment. FIG. 2c shows an embodiment where magnetic transfer element 105 may be attached to shafts 111a, 111b. Each shaft 111a, 111b may then be connected to a separate rotational source, each of which may rotate in different directions in an alternating fashion to produce a rocking motion. The rotational motion of the magnetic transfer element 105 may be in a discontinuous or discrete mode, but the reciprocating action of the tool tip 102 remains in a continuous mode.

When one motor is used for the motion generation, there is a potential for creating some hysteresis in the motor. The hysteresis generated may eventually shut down the motor and either the instrument or the motor may be replaced. In this embodiment, it may be advantages to employ separable parts for the instrument or tool for more ease of part replacement or reuse.

When more than one motor is used, only one motor is on at a time.

Magnetic transfer elements may be particularly desirable for motion generating mechanism as the elements may still influence each other without being in direct contact, which may offer increase in design flexibility. Portions of the dental tool may also be physically isolated for contamination control without significantly interfering with the influence of the magnetic transfer elements on each other, such as shown in FIG. 3f.

In some embodiments, the interior of the dental tool 100 may be sectioned such that the tool tip 102 and magnetic transfer element 103 may be isolated within section 104a from the other components of the dental tool 100. This may aid in preventing contaminants from entering section 104b from the outside through section 104a. The section 104a may be isolated from the section 104b, which may contain, for example, other components such as the magnetic transfer element 105, drive shaft 111, rotational source 110 and/or any other internal components of the dental tool 100. A partition 104c may be employed to maintain the separation of the sections 104a, 104b.

The rotational source 110 may be any appropriate source, such as, for example, an electric motor, such as a permanent magnet DC motor, or a stepper motor; a transducer; a turbine and/or any other appropriate source. A turbine may in general be powered by an outside source of pressurized gas or fluid, such as the pressurized air line in a dental office. The rotational source 110 may be, in the case of an electric motor, powered by an appropriate source such as, for example, a battery, capacitor, an outside electrical energy source and/or combinations thereof. In general, a battery or other portable energy source may be desirable such that the dental tool 100 may be portable and un-tethered. Portable energy sources may include, but are not limited to, a removable battery or a non-removable rechargeable battery such as a carbon zinc battery, an alkaline battery, a Nickel Metal Hydride battery, a Nickel Cadmium battery, a lithium ion battery, a lithium polymer battery; a capacitor; an electrical fuel cell, or a fuel storage reservoir; and/or any other appropriate portal energy source. It may also be generally more desirable for the energy source to be rechargeable and/or easily replaceable.

The instrument may also include a battery charging circuit adapted to receive electrical energy from an external electrical energy source. Accordingly, the instrument may be coupled to a source of household voltage on an as-required basis, and the battery charging circuit then provides an appropriate charging current to the re-chargeable battery of the active instrument.

In some embodiments, the dental tool 100 may include an electronics package 120 which may include an internal power source, such as a battery, and/or control circuitry for the dental tool 100, as shown in FIG. 2. The electronics package 120 may be housed within the body 104 and may provide power to the rotational element or source 110 via an electrical connection 107. The electronics package 120 may further interface with actuator 106 such that a user may control rotational source 110.

In another aspect, the dental tool may include separable or modular components. In general, dental tools are sterilized prior to use to reduce contamination risk and maintain a clean environment. As such, it may be desirable for the dental tool to include easily sterilizable components. The components may also be separably replaceable. Separable components may also be environmentally desirable so that only the components that are worn are replaced.

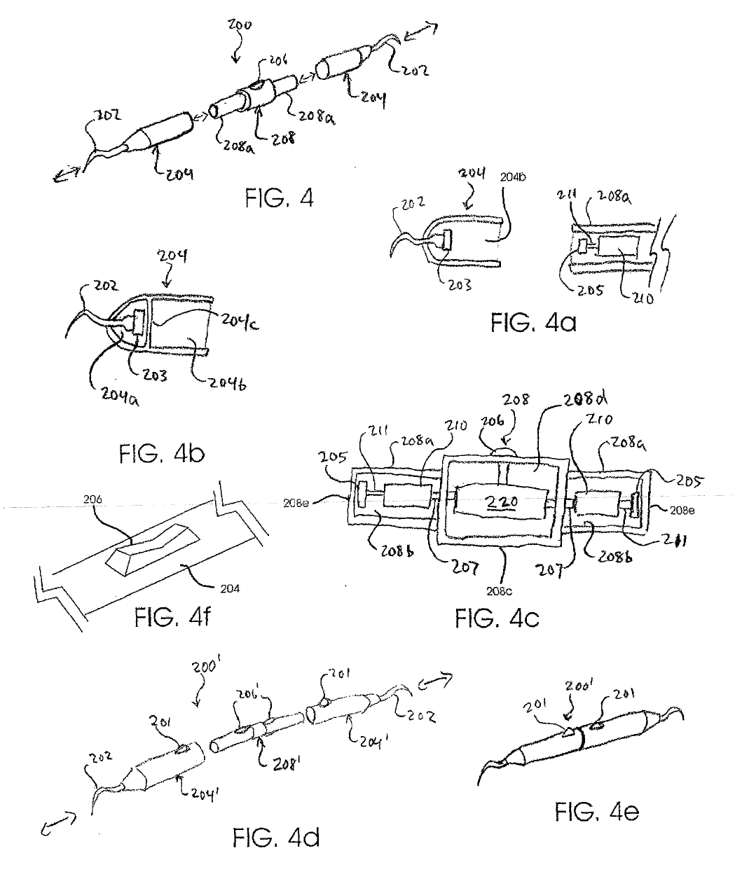

A dental tool 200 may also include separable tool tip sections 204, as illustrated in FIG. 4. Each tool tip section 204 may include a tool tip 202. Any powered and/or temperature/moisture sensitive components of the dental tool 200 may in general be disposed such that they may be retained in a portion of the dental tool 200 separate from the separable tool tip sections 204, such as with drive cartridge 208. This configuration may be utilized to separately sterilize tool tip sections 204 from the drive cartridge 208. The tool tip sections 204 may be sterilized by an appropriate method, such as, for example, autoclaving. The separable tool tip sections 204 may also include housing portions that may substantially cover portions of the dental tool 200 that are not sterilized, such as the portions 208a of the drive section 208. The housing portions of the tool tip sections 204 may generally include a hollow interior 204b, as shown in FIG. 4a, and may follow the general contour/shape of the portions 208a. The housing portions may also feature surface formations and/or features such as bumps, and/or depressions, that may generally improve the ease by which the dental tool 200 may be handled and/or gripped.

The dental tool 200 generally includes a motion generating mechanism which may include a rotational source 210 and at least one set of opposing magnetic transfer elements 203, 205, as exemplified in FIG. 4a, which may be substantially identical to the above discussed magnetic transfer elements 103, 105 and rotational source 110. The tool tips 202 may be reciprocated along the longitudinal axis by rotating the magnetic transfer element 205 coupled to the drive shaft 211 of the rotational source 210.

The separable tool tip sections 204 and/or the drive cartridge 208 of the dental tool 200 may also include partitions 204c, 208e, respectively, as shown in FIGS. 4b and 4c. The partitions 204c, 208e may substantially isolate portions of the separable tool sections 204 and/or the drive cartridge 208 during use in a manner similar to the partition 104c discussed above. This may aid in maintaining sterility and preventing cross-contamination as, in general, the separable tool tip section 204 may be sterilized and/or replaced for each patient while the other components are not. The partitions 204c, 208e may also be removable such that the internal components of the separable tool tip sections 204 and the drive cartridge 208 may be accessed. The partitions 204c, 208e may also be replaceable such that the isolation may be maintained or restored if the partitions are damaged or lost.

In some embodiments, the drive cartridge 208 may include at least one actuator 206 which may control the at least one rotational source 210, as shown in FIG. 4c. The actuator(s) 206 may interface with the electronics package 220 which may generally control and provide power to the rotational source 210 via electrical connections 207. The rotational source 210 may be isolated within hollow section 208b from the electronics package 220 in hollow section 208d or they may be present in a continuous hollow space (not shown).

In one embodiment, a single actuator 206 may be utilized to control a single rotational source 210. In another embodiment, a single actuator 206 may be utilized to control multiple rotational sources 210. This may be accomplished by sequential control, whereby subsequent actuations may trigger controls in a sequence. For example, a first actuation may turn on a first rotational source, a second actuation may turn off a first rotational source and turn on a second rotational source, and a third actuation may turn off the second rotational source. In general, an actuator 206 or combinations of actuators may be designed and utilized to affect a desired operational scheme.

In an exemplary embodiment, the dental tool 200 may include an actuator 206 which may be a rocker switch, as illustrated in FIG. 4f. The rocker actuator 206 may include three positions, which may be first rotational source on, all off, and second rotational source on.

In another embodiment, a dental tool 200′ may include separate actuators 206′, which may be utilized to affect separate rotational sources 210, as shown in FIG. 4d.

In some embodiments, the drive cartridge may include an exposed section or sections 208c, as shown in FIGS. 4 and 4c. The exposed section 208c may in general have the at least one actuator 206 disposed thereon such that the actuator 206 may be accessible during operation.

In other embodiments, the drive cartridge may be designed to be fully enclosed. FIG. 4d illustrates an embodiment of a dental tool 200′ where the drive cartridge 208′ may be fully enclosed by the separable tool tip sections 204′ when assembled. The tool tip sections 204′ may include a surface interface 201 which may actuate a corresponding actuator 206′ such that the actuator 206′ may be utilized without being exposed, as shown in FIG. 4e. The surface interface 201 may substantially fit over the actuator 206′ and may be matching in size and/or contour. The surface interface 201 may also be, for example, a flexible membrane switch, a spring-loaded switch and/or any other appropriate interface.

In other embodiments, the powered and/or temperature/moisture sensitive components of the dental tool may be removable from the dental tool such that the dental tool may be sterilized separately.

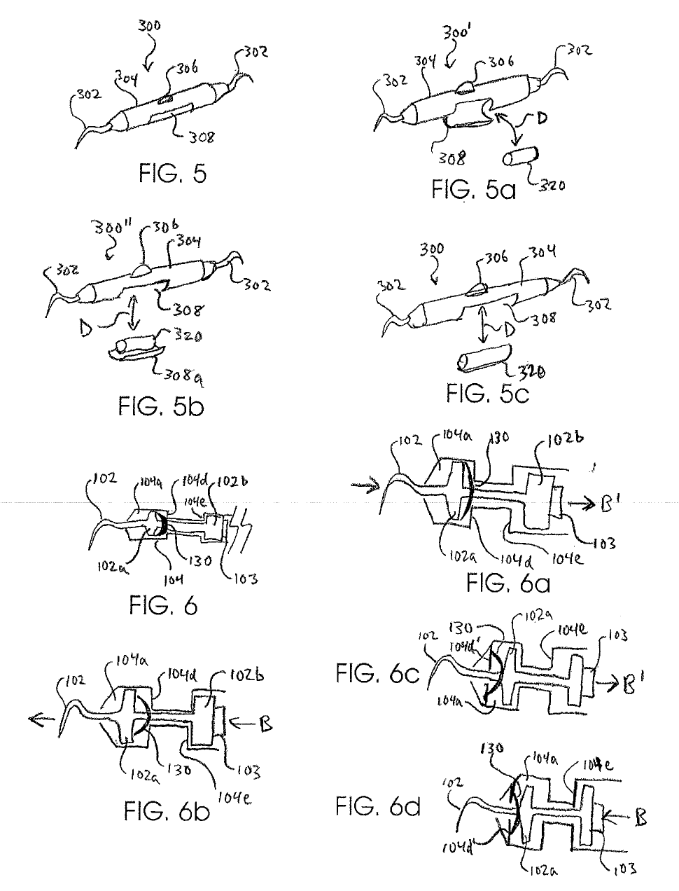

A dental tool 300 that may also include removable powered and/or temperature/moisture sensitive components, is illustrated in FIGS. 5, 5a, 5b and 5c. In general, the dental tool 300 may include an aperture 308, which may open to remove components 320. The aperture 308 may be closed by any appropriate structure, which may include, but is not limited to, a swinging plate, as shown in FIG. 5a, or a drop out plate 308a, as shown in FIG. 5b. The removable components 320 may also be adapted to form part of the structure of the dental tool body 204, as shown in FIG. 5c.

In some embodiments, the dental tool may further include a spring element. A spring element 130 may generally bias the tool tip 102 against motion along its longitudinal axis such that it may resist loads in a given direction. The spring element 130 may further aid in returning the tool tip 102 to a starting position in each reciprocating action.

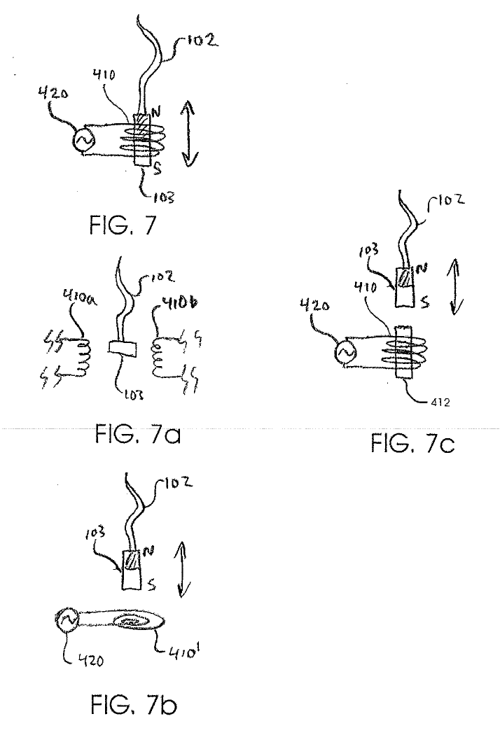

FIG. 6 illustrates the use of a spring element 130 to bias tool tip 102. The dental tool body 104 may include restraining surfaces 104d, 104e, which may restrict the longitudinal movement of the tool tip 102 by butting against sections 102a, 102b, respectively. The sections 102a, 102b of the tool tip 102 may in general be spaced such that only one butts against a restraining surface at a time. A spring element 130 may be disposed such that it biases section 102a against restraining surface 104d. This configuration may be utilized to substantially prevent the tool tip 102 from moving longitudinally when being pulled in a proximal direction (i.e. toward the magnetic transfer element 103). The spring element 130 may also return the tool tip 102 to a default position during or after powered usage with the magnetic transfer element 103. This may be particularly desirable when utilizing a single pole domain magnetic transfer element 103 which may only be capable of producing a substantial force in a single direction. The spring element 130 may provide a counter direction force B against a magnetic force B′, as shown in FIGS. 6a and 6b. The spring element 130 may also be used with multiple pole domain magnetic transfer element 103, as discussed above.

The spring element 130 may also be butted against a forward restraining surface 104d′, as shown in FIGS. 6c and 6d. This configuration may be utilized to substantially prevent the tool tip 102 from moving longitudinally when being pushed in a distal direction longitudinally (i.e. away from the magnetic transfer element 103).

In general, the body portion 104 of the dental tool 100 may include features or formations that may restrain the tool tip in attachment to the dental tool and restrict the motion of the tool tip to a given range. Suitable features or formations may include, but are not limited to, restraining members, varied cross-section regions, bushings, bearings and/or any other appropriate features or formations.

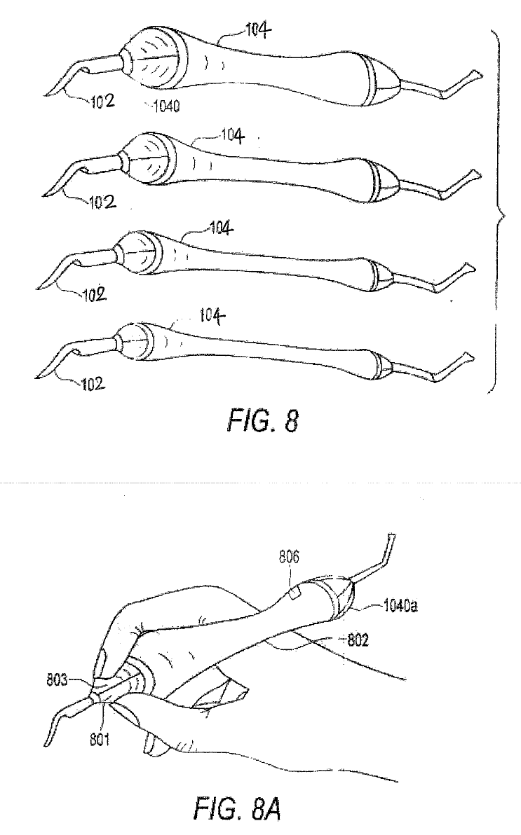

In other embodiments, other magnetic motion generating mechanism may be utilized. FIG. 7 illustrates an embodiment of a magnetic motion generating mechanism that may include a magnetic transfer element 103, a coil 410 and an alternating current (AC) source 420. The magnetic transfer element 103 may include at least one North pole domain and one South pole domain and may be coupled to the tool tip 102. A coil 410 may be wound about the magnetic transfer element 103 such that the magnetic transfer element 103 is generally disposed along the axis of the coil 410. The coil 410 may be connected to an AC source 420 such that the current in the coil 410 may generate a magnetic field. The magnetic field may in general alternate polarity in response to the AC current such that the domains of the magnetic transfer element 103 may, in an alternating fashion, positively align in polarity with the magnetic field of the coil 410, i.e. North to South, and negatively align, i.e. North to North or South to South. The alternating positive and negative alignments of polarity may in general generate a reciprocating motion of the magnetic transfer element 103 and the coupled tool tip 102 along the magnetic axis of the coil 410.

In other embodiments, multiple coils 410a, 410b, etc. may be utilized, as illustrated in FIG. 7a. Other forms of coils may also be utilized, such as a flat coil 410′, as shown in FIG. 7b.

In still another embodiment, the coil 410 may include a core 412, as illustrated in FIG. 7c. Adding a ferromagnetic core 412 may increase the magnetic field strength of the coil 410. This may result in an overall stronger force upon the magnetic transfer element 103 and thus create a stronger reciprocating action of the tool tip 102. Any suitable ferromagnetic material may be utilized in construction of the core 412 and may include, but is not limited to, iron, steel, ferrite, ferromagnetic transition metals, ferromagnetic ceramics and/or any other appropriate ferromagnetic material or combinations thereof.

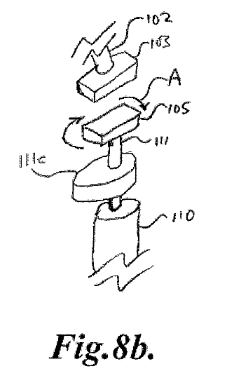

The present invention may also include sets of identical or different instruments, as shown in FIG. 8, having handles made with varying diameters for grasping, designed to be used interchangeably throughout the day, thus cutting down on the repetitive grasping action through the change of grasp. Therefore, even if a dental professional uses the same type of instrument throughout the day, the hands, wrists and elbows may experience varying rather than repetitive action because the positioning of the hands, wrists and elbows are interchanging throughout the day.

The dental instrument includes an elongated body 104, as shown in FIG. 8, having an interior that may be solid, hollow or partially solid. The elongated body 104 has a distal end and a proximal end. A portion of the body 102 may serve as a handle for grasping by the dental professional, as noted above. The distal end has a dental tip 102 extending therefrom, and permanently or removably connected to the distal end of the body 104.

The handles may further be ergonomically designed, as exemplified in FIG. 8. The identical instruments with varying diameter handles may be used interchangeably throughout the day. Combining the varying diameters with the more ergonomically designed handles, the handles can go a long way to relieving stress to the hands, wrists and elbows of dental professionals.

The details of instruments having varying diameters are described in an U.S. patent application Ser. No. 11/230,712, entitled “Dental Instruments with Stress Relief”, the contents of which are incorporated herein by reference in their entirety.

As shown in FIG. 8, each of the instruments includes a handle portion 104 and a tooth contacting portion 102, which is, in the illustrated embodiment, a scaler tip.

The handle portion 104 is cylindrical and may be of a solid core or a hollow core, having a distal end and a proximal end. As an illustration, the diameters of the handles vary. In other embodiments, a series with different numbers of handles with varying diameters or different instruments is contemplated. The sets of identical instruments made with varying diameters for grasping, may cut down on the repetitive action, as noted above.

The handle 104 may be tapered toward either the distal end or the proximal end or both, or as exemplified, towards the mid-section, and extending from the distal end or ends are the dental tips 102 adapted to be used on a patient's teeth or tooth.

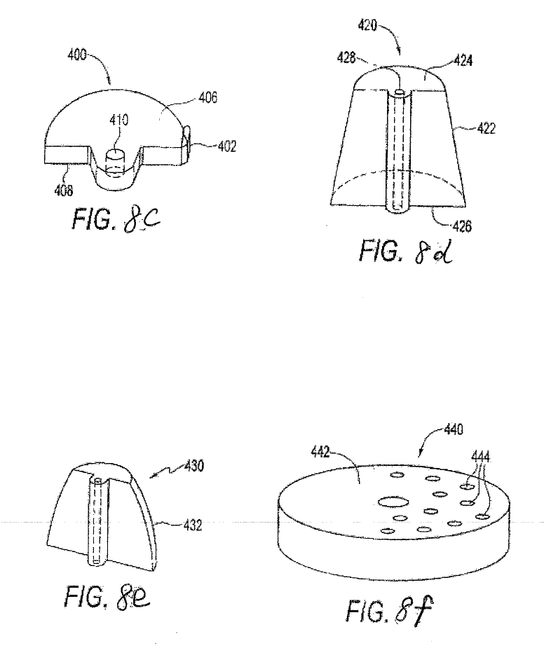

FIG. 8a illustrates an embodiment of the body portion or grip portion 1040a in more detailed. The grip portion may have a hollow interior, as shown in FIG. 9.

The handle portion 104 may be made of metal or plastic. The cone shaped portion or tapered portion 1040a may be made of the same or different material from the rest of the handle. A suitable metal may include, for example, stainless steel, titanium, titanium alloys such as nickel-titanium and titanium-aluminum-vanadium alloys; aluminum, aluminum alloys; tungsten carbide alloys and combinations thereof. More for example, the materials are stainless steel and titanium alloys. These also, for example, have good flexibility. A suitable non-metal may include a polymeric material, such as high temperature plastics including

reinforced or unreinforced polymers such as, for example, polyamide (nylon); ultrahigh molecular weight polyethylene (UHMWP); Polyacetyl (Delrin); Polyaramid (Kevlar); ULTEM®, which is an amorphous thermoplastic polyetherimide, Xenoy® resin, which is a composite of polycarbonate and polybutyleneterephthalate, Lexan® plastic, which is a copolymer of polycarbonate and isophthalate terephthalate resorcinol resin (all available from GE Plastics); liquid crystal polymers, such as an aromatic polyester or an aromatic polyester amide containing, as a constituent, at least one compound selected from the group consisting of an aromatic hydroxycarboxylic acid (such as hydroxybenzoate (rigid monomer), hydroxynaphthoate (flexible monomer), an aromatic hydroxyamine and an aromatic diamine, (exemplified in U.S. Pat. Nos. 6,242,063, 6,274,242, 6,643,552 and 6,797,198, the contents of which are incorporated herein by reference in their entirety), polyesterimide anhydrides with terminal anhydride group or lateral anhydrides (exemplified in U.S. Pat. No. 6,730,377, the content of which is incorporated herein by reference in its entirety) or combinations thereof.

In addition, any polymeric composite such as engineering prepregs or composites, which are polymers filled with pigments, carbon particles, silica, glass fibers, conductive particles such as metal particles or conductive polymers, or mixtures thereof may also be used.

The handle may be in the triangular shape, as shown in FIG. 8a, with a mid-section of a smaller circumferential distance than the gripping areas when the tip extends from on both ends. It may also be rounded in the mid-section. Both of these configurations may also be formed with bumps or striations, for example, as exemplified in FIG. 9 as 1040, about the grasping areas to facilitate grasping.

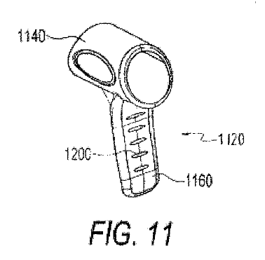

The hand grip 1040a may be fabricated using thermoplastic elastomers such as SANTOPRENE® available from the Monsanto Company, or those used in the construction of some tips, or any other suitable material, as mentioned before. The hand grip 1040a may be formed through injection molding in some embodiments. In other embodiments, the hand grip 1040a may be a one-piece construction. In still other embodiments, multi-piece hand grips may be used. By way of an example, a two-piece handgrip may be ultrasonically welded together over the handle 804. The hand grip 1040a may have a generally cylindrical shape, or may shape like a pistol, as shown in FIG. 11 as 1120.

The hand grip or resilient material may also be either a natural or synthetic rubber. Synthetic rubbers may be, for example, elastomeric materials and may include, but not limited to, various copolymers or block copolymers (Kratons®) available from Kraton Polymers such as styrene-butadiene rubber or styrene isoprene rubber, EPDM (ethylene propylene diene monomer) rubber, nitrile (acrylonitrile butadiene) rubber, latex rubber and the like. Foam materials may be closed cell foams or open cell foams, and may include, but is not limited to, a polyolefin foam such as a polyethylene foam, a polypropylene foam, and a polybutylene foam; a polystyrene foam; a polyurethane foam; any elastomeric foam made from any elastomeric or rubber material mentioned above.

According to one embodiment of the invention, as also shown in FIG. 8a, the instrument includes a resilient material 803 disposed on the outer surface 801 of the handle 804 to work also as a hand grip, as described above. The resilient material 803 serves to cushion the grip of the dental professional during application of the instrument. According one aspect, the invention includes a switching device 806 supported by the handle portion 804. The switching device 806 allows a user to activate, and deactivate, the vibrational mechanism disposed within the handle portion 804.

According to one aspect of the invention, as shown in FIG. 8a, a vibrational mechanism may also be included within the handle portion 804. The vibrational mechanism is adapted to induce vibrations of an outer surface 801 of the handle 804, or a portion thereof 802. The vibrations may include a variety of modes including flexural and elastic linear modes and rotational modes. The vibrations may provide a soothing effect to the hand of the dental professional employing the instrument. The vibratory mechanism may have its own motion generating source or motor or may employ the same motion generating source or motor already present in the instrument for activating the rotational motion mechanism.

The separate motion generating source or motor, if used, can be any vibrational transducer including a linear motor such as a solenoid, a piezoelectric transducer or a linear stepper motor.

In one embodiment, as shown in FIG. 8b, an eccentric weight 111c may be disposed on the shaft 111 which may be rotated by rotational source 110. The eccentric weight 111c may then generate a vibration of the instrument as it rotates due to the wobbling motion of the mass.

FIG. 8c shows an eccentric load 400 according to one embodiment of the invention. The eccentric load includes a mass having an arcuate circumferential surface 402 disposed between first 406 and second 408 substantially planar side surfaces. A substantially cylindrical inner surface 410 is disposed between the first and second substantially planar surfaces to define a bore having a longitudinal axis. The longitudinal axis is disposed in substantially parallel spaced relation to an axis of rotation through the center of mass of the eccentric load 400.

In a further embodiment, as shown in FIG. 8d, the eccentric load 420 includes a truncated section of a conical surface 422 disposed between first 424 and second 426 substantially planar side surfaces. A substantially cylindrical inner surface 428 is disposed between the first and second substantially planar surfaces to define a bore having a longitudinal axis. The longitudinal axis is disposed in substantially parallel spaced relation to an axis of rotation through the center of mass of the eccentric load. The resulting conical shape of the FIG. 8b eccentric load 420 is an eccentric load having a mass that diminishes linearly as a function of distance along the motor shaft away from the motor.

In a still further embodiment, as shown in FIG. 8e, the eccentric load 430 includes a truncated section of an ellipsoidal surface 432 disposed between first and second substantially planar side surfaces. The resulting ellipsoidal shape of the FIG. 8c eccentric load 430 results in an eccentric load having a mass that diminishes non-linearly as a function of distance along the motor shaft away from the motor.

In yet another embodiment the elliptical load includes a wheel that is substantially spatially symmetric. However the distribution of mass within the substantially spatially symmetric volume is skewed to produce a dynamically unbalanced load. According to one embodiment, as shown in FIG. 8f, the skewed distribution of mass is produced by forming the wheel 440 of a first material 442 and embedding particles of a second material 444 in a spatially nonuniform distribution within first material.

Details of a vibratory mechanism are described in U.S. patent application Ser. No. 11/230,710, the contents of which are hereby incorporated by reference in their entirety.

In addition, each of the instruments described above may also be made with an anti-rotation means for preventing said vibrator module from rotating relative to said housing when said vibratory tool is in use.

Furthermore, the body portion 104 may include portion 1040, as to be discussed further below in FIG. 9, which may be rotatable wherein such rotation also rotates the dental tip 102 so that the tip 102 may be easily repositioned without being taken out of the patient's mouth. Portion 1040 may be cone-shaped.

In one embodiment, portion 1040 may be integrally constructed as part of the handle 104 or it may be constructed separately, by either molding, brazing, threadably connected or any other type of attachment to attach the tip 102 onto either the distal or the proximal end of the handle 104.

FIG. 9 shows an instrument 900 having a rotatable tip 902. Such a rotatable tip 902 may also be used in each of the instruments shown above. The tip 902 is fixedly or removably coupled to a collar or rotator head 904 of the tapered portion 114. Rotation of the collar or rotator head 904 also rotates the dental tip 902 so that the tip 902 may be easily repositioned without being taken out of the patient's mouth. A detent mechanism prevents rotation of the collar 904 and tip 902 when such rotation is not desired. The detent mechanism may be released to allow rotation by, for example, pressing a release button 906. The mechanism for rotation is similar to that described in the patent application U.S. Ser. No. 10/735,050, the contents of which are incorporated herein by reference in their entirety.

The cone-portion or tapered portion 114, if removable, is, for example, made of a plastic material even if the rest of the handle is made of a metal or metal alloy.

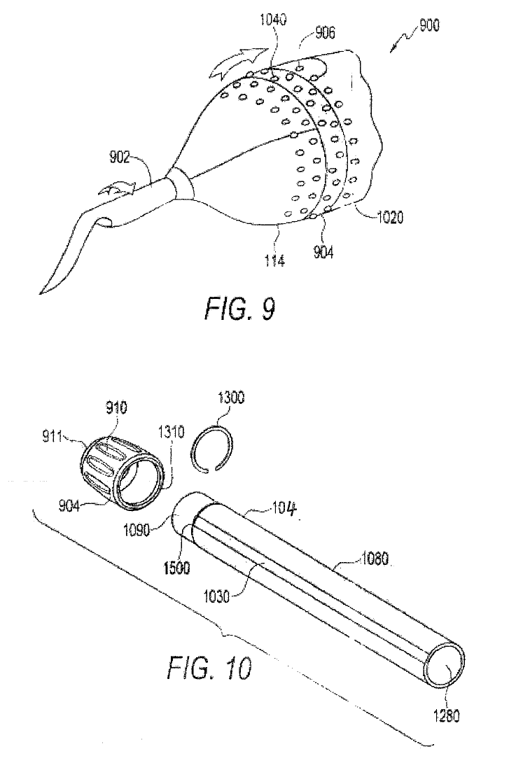

As shown in FIGS. 9 and 10, the rotator head 904 located at a distal end of the handpiece 900 is rotatably coupled to the rest of the handpiece 900. The rotator head 904 may have a generally cylindrical shape, a hollow interior, and an opening at each end of the interior, which is used to receive the distal end of the body 104 at one end and a dental tip 902 at the other end. For example, at its distal end, the rotator head 904 has formed thereon an opening 911 for receiving a tip 902.

The rotator head 904 may have formed around its outer peripheral surface a plurality of indentations 910. Each indentation 910 may have an elongated elliptical (or rectangular) shape with its major axis in the direction parallel to the central axis of the handpiece 900. The indentations 910 facilitate grasping of the rotator head 904 by a dental practitioner to rotate it, for example, with respect to the body 104 (e.g., using only one hand). In other embodiments, the rotator head 904 may have a number of protrusions formed thereon instead of the indentations.

Referring now to FIGS. 9 and 10, the handpiece 900 further includes a retainer ring 1300, which may be made of metal, for example any of those mentioned above. The retainer ring 1300 may be substantially circular in shape, but does not quite form a complete circle. The retainer ring 1300 may be flexible (resilient) and works as a spring in that the ends that are not connected together may be brought closer together by applying pressure, and separate when the pressure is removed.

The rotator head 904 may have formed on the inner surface near its proximal end a circular groove 1310, as exemplified in FIG. 10, that may be used to engage the retainer ring 1300. The retainer ring 1300 may be installed in the circular groove 1310, for example, by applying pressure on the retainer ring 1300 to compress it, and releasing it once the retainer ring 1300 has been aligned with the groove 1310. Upon installation, the retainer ring 1300 is locked to and is fixed with respect to the rotator head 904.

After locking the retainer ring 1300 to the groove 1310, the rotator head 904 is coupled with the body 1020 by receiving the distal end of the body 104 into the rotator head opening at its proximal end. The body 104 may have formed at its distal end an engagement portion 1090, which has a radius that is smaller than the radius of the rest of the body 104. At a joint between the engagement portion 1090 and the rest of the body 104 may be formed a circular groove 1500 on an outer surface of the engagement portion 1030. When the engagement portion 1090 is inserted into the rotator head 904, the retainer ring rotatably engages the groove 1500 such that the rotator head 904 is rotatably coupled to the body 104. In other embodiments, the retaining ring may be fixedly coupled to the body 1020 and rotatably coupled to the rotator head 904.

The body 104 has formed thereon a pair of grooves 1030 that are equidistant from the top and traverse substantially the whole length of the body 104. The grooves 1030 may be used to mount a different type of hand grip 1120, as shown in FIG. 11, on the handpiece 900. The body 104 may have also formed thereon at its bottom near the distal end of the body 104, a plurality of substantially evenly spaced slots 1080 that may be used to keep the hand grip 1120 from moving in the direction of the axis of the handpiece 900. The body 104 may also have formed thereon at its bottom near the proximal end a groove (not shown) that is co-linear to the slots 1080. The groove may engage the hand grip 1120 together with the grooves 1030 to keep the hand grip 1120 from rotating about the central axis of the handpiece 900.

The hand grip 1120 may have an engagement portion 1140, which has a generally cylindrical shape and a hollow interior, as exemplified in FIG. 11. The engagement portion 1140 is adapted to be slipped onto the body 104, similar to a sleeve, and engages the body 104 such that the engagement portion envelopes a portion of the body 104. The engagement portion may have formed thereon a resilient cantilever portion (not shown), which may be used to engage one of the slots 1080 on the body 104. The engagement portion 1140 may have attached to its bottom surface a handle 1160, which may be grasped by a dental practitioner to hold the handpiece 900 during dental procedures. The handle 1160 may also facilitate rotating of the rotator head 904 using one hand. The handle 1160 may have formed on its back surface a plurality of indentations or protrusions 1200, which are used to facilitate grasping by a dental practitioner.

The hand grips may also be made with varying diameters for grasping, designed to be used interchangeably throughout the day, coupled with more ergonomically designed handles.

More details of this hand grip 1120 may be found in U.S. patent application Ser. No. 10/998,259, the contents of which are hereby incorporated by reference in their entirety.

Heat tends to be generated about the tip during use due to frictional forces. Therefore, a coating having high lubricity can generally decrease the frictional forces and hence the heat generated, leading to reduced patient discomfort during the dental process. Suitable coatings that have high lubricity include diamond-like carbon (DLC) coatings including at least about 5 atomic percent of hydrogen. The details of durable coatings is described in a U.S. patent application Ser. No. 11/230,605, entitled “Dental Tool Having A Durable Coating”, the content of which is hereby incorporated by reference in its entirety.

In one example, the instrument may be constructed with the tip 102 and the hand grip 104 already assembled prior to coating the tip with a DLC coating. This process is possible because the low coating temperature of the coating processes approximates that of autoclaving. This gives flexibility in the assembly of the instrument.

While exemplified embodiments of the invention have been described and illustrated above, it should be understood that these are exemplary of the invention and are not to be considered as limiting. Accordingly, the invention is not to be considered as limited by the foregoing description, but is only limited by the scope of the claims appended hereto.

1. A dental tool comprising:
a substantially hollow body portion;
at least one tool tip disposed on said body portion, said tool tip having a longitudinal axis, a proximal end and a distal end;
a first magnetic transfer element coupled to the proximal end of said tool tip; and
at least one motion generating mechanism comprising a second magnetic transfer element disposed in proximity to said first magnetic transfer element, and a rotational source for rotating the second magnetic transfer element; wherein said first and second magnetic transfer elements interact to generate a vibratory reciprocating motion of the tool tip substantially along the longitudinal axis.

2. The dental tool of claim 1, wherein the body further comprises at least one partition in proximity to the tip.

3. The dental tool of claim 1, wherein said dental tool forms part of a set of dental tool comprising a body portion having varying diameters for grasping.

4. The dental tool of claim 1, wherein said rotational source rotates said second magnetic transfer element in a continuous mode.

5. The dental tool of claim 1, wherein said rotational source rotates said second magnetic transfer element in a discrete rocking, oscillating or flipping action.

6. The dental tool of claim 2, wherein said partition physically separates the first and second magnetic transfer elements.

7. The dental tool of claim 1 further comprising an actuator on the body for activating the rotational source.

8. The dental tool of claim 1 further comprising at least one power source positioned inside the body.

9. The dental tool of claim 1 further comprising a spring element for biasing the tool tip against motion along its longitudinal axis.

10. The dental tool of claim 1 wherein at least one of said magnetic elements comprises multiple magnetic pole domains.

11. The dental tool of claim 1 wherein said rotational source comprises at least one motor, one transducer, one turbine or combinations thereof for rotating said second magnetic element.

12. The dental tool of claim 1 wherein at least a portion of said first and second magnetic elements are in contact with each other.

13. The dental tool of claim 5 wherein said motion generating mechanism comprises at least two separate motors that are on at different times.

14. A dental tool comprising:
a substantially hollow body;
at least one tool tip disposed on said body, said tool tip having a longitudinal axis, a proximal end and a distal end;
at least one magnetic transfer element coupled to the proximal end of said tool tip; and
at least one motion generating mechanism comprising at least one coil in close proximity to said at least one magnetic transfer element, and an alternating current source for powering the coil to generate a vibratory reciprocating motion of the tool tip substantially along the longitudinal axis.

15. The dental tool of claim 14 further comprising a ferromagnetic core disposed within the coil.

16. The dental tool of claim 14 wherein said at least one coil comprises a flat coil.

17. The dental tool of claim 14, wherein the body further comprises at least one partition in proximity to the tip.

18. The dental tool of claim 17, wherein said partition physically separates the at least one magnetic transfer element and the at least one coil.

19. The dental tool of claim 14 further comprising an actuator on the body for activating the alternating current source.

20. The dental tool of claim 14 further comprising a spring element for biasing the tool tip against motion along its longitudinal axis.

21. A dental tool comprising:
a substantially hollow body;
at least one tool tip disposed on said body, said tool tip having a longitudinal axis, a proximal end and a distal end;
a first magnetic transfer element comprising at least one surface having at least a pair of North and South magnetic pole domains disposed on said surface, said first magnetic transfer element being coupled to the proximal end of said tool tip; and
at least one motion generating mechanism comprising a second magnetic transfer element in proximity to said first magnetic transfer element, the second magnetic transfer element comprising at least one surface proximal to the at least one surface of the first magnetic transfer element, and having at least a pair of North and South magnetic pole domains disposed on said surface, and a rotational source for rotating the second magnetic transfer element.

22. The dental tool of claim 21 wherein said rotational source rotates the second magnetic transfer element to alternate alignment and misalignment of the pairs of North and South magnetic pole domains of the first and second magnetic transfer elements to generate a vibratory reciprocating motion of the tool tip substantially along the longitudinal axis.

23. The dental tool of claim 21 wherein said rotational source rotates the second magnetic transfer element to alternate alignment and misalignment of the pairs of North and South magnetic pole domains of the first and second magnetic transfer elements in a discrete mode to generate a vibratory reciprocating motion of the tool tip substantially along the longitudinal axis.

24. The dental tool of claim 21 wherein said rotational source rotates the second magnetic transfer element to alternate alignment and misalignment of the pairs of North and South magnetic pole domains of the first and second magnetic transfer elements in a continuous mode to generate a vibratory reciprocating motion of the tool tip substantially along the longitudinal axis.

25. The dental tool of claim 21, wherein the body further comprises at least one partition in proximity to the tip.

26. The dental tool of claim 25, wherein said partition physically separates the first and second magnetic transfer elements.

27. The dental tool of claim 24 further comprising a spring element for biasing the tool tip against motion along its longitudinal axis.
